(19) United States
(12) Patent Application Publication
(10) Pub. No.: US 2002/0122680 A1
(43) Pub. Date: Sep. 5, 2002

(54) Cleaning device for a fixing unit

(76) Inventors: Eita Sakaba, Ibaraki (JP); Masami Takeshita, Ibaraki (JP); Masato Miwa, Ibaraki (JP); Osamu Nishino, Ibaraki (JP)

Correspondence Address: McGinn & Gibb, PLLC, Suite 200, 8321 Old Courthouse Road, Vienna, VA, 22182-3817, US

(21) Appl. No.: 10/015,900

(22) Filed: Dec. 17, 2001

(30) Foreign Application Priority Data
Mar. 2, 2001 (JP) P2001-057551

(51) Int. Cl. G03G 15/20

(52) U.S. Cl. 399/326; 399/327

(57) ABSTRACT

In a cleaning device for a fixing unit, a notched portion is formed in a winding shaft, which has an unused web wound therearound, at a position opposing a detecting position of a sensor. Accordingly, when a trailing end of the web comes to be exposed, and the web is disengaged from the wining shaft, the sensor measures the diameter of the notched portion, so that the diameter changes substantially. For this reason, an output of the sensor also changes substantially, and the trailing end of the web can be detected easily without being affected by the sensitivity of the sensor.

### BACKGROUND OF THE INVENTION

1. Field of the Invention

The present invention relates to a cleaning device for a fixing unit used in an electrophotographic apparatus such as a printer and a copying machine.

2. Description of the Related Art

In a conventional cleaning device for a fixing unit used in an electrophotographic apparatus, an actuator of a sensor is made to abut against an outer peripheral portion of an unused web whose diameter gradually decreases as the web is taken up, and the position of the actuator is detected by the sensor so as to detect a trailing end of the web.

In a conventional cleaning device for a fixing unit, a system is used in which the trailing end of the web is detected by detecting the outside diameter of the unused web by a sensor. However, the difference between the outside diameter of the unused web and the outside diameter of the shaft is small in the vicinity of the trailing end of the web, so that it has been difficult to discern whether or not the web still remains depending on the sensitivity of the sensor. In addition, since cleaning becomes faulty if the web is used up, it has been necessary to detect the trailing end of the web with sufficient leeway. For this reason, there has been a problem in that the unused web is wasted.

### SUMMARY OF THE INVENTION

An object of the present invention is to solve the above problem.

To overcome the above-described problem, in a cleaning device for a fixing unit in accordance with the invention, a notched portion is formed in a winding shaft, which has an unused web wound therearound, at a position opposing a detecting position of a sensor. When a trailing end of the web comes to be exposed, and the web is disengaged from the wining shaft, the diameter of the notched portion of the winding shaft is measured although the diameter of the web was being measured up until then, so that the diameter changes substantially. For this reason, an output of the sensor also changes substantially, and the trailing end of the web can be detected easily without being affected by the sensitivity of the sensor.

In the cleaning device for a fixing unit having the above-described arrangement, the web may be impregnated with silicone oil to exhibit an oil applying function.

### BRIEF DESCRIPTION OF THE DRAWINGS

FIG. 1 is a perspective view illustrating an embodiment of the cleaning device for a fixing unit in accordance with the invention.

### DETAILED DESCRIPTION OF THE PREFERRED EMBODIMENTS

Referring now to the drawing illustrating an embodiment, a description will be given of the invention.

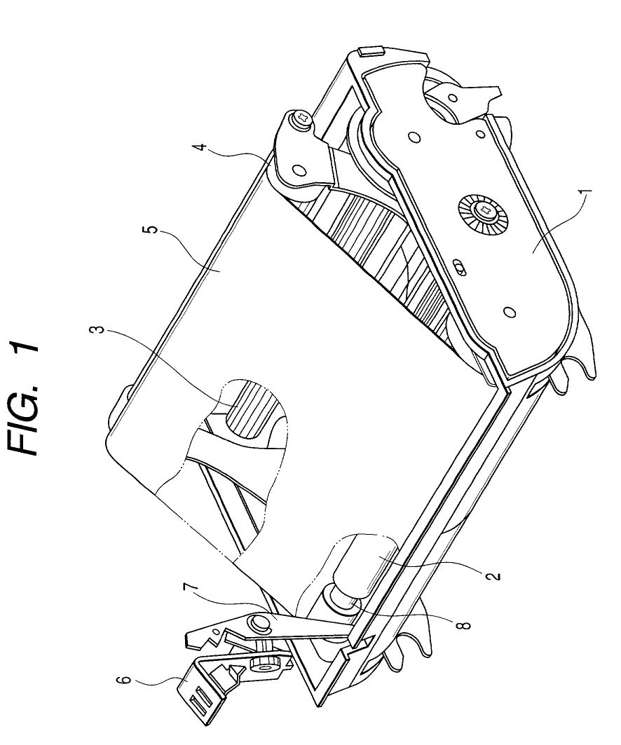

In FIG. 1, a cleaning device for a fixing unit is comprised of a frame 1; a shaft 2 with an elongated unused web 5 wound therearound; a web takeup shaft 3; a roller 4 for pressing the web 5 against a heating roller (not shown) or a pressure roller (not shown); and a web-trailing-end detecting sensor 6 attached to a printer (not shown). As the web 5 cleans the heating roller (not shown) or the pressure roller (not shown), the web 5 is taken up onto the web takeup shaft 3. When a trailing end of the web 5 comes to be exposed, and the web 5 is disengaged from the shaft 2 around which the unused web 5 was wound, an actuator 7 of the sensor 6 falls into a notched portion 8 of the shaft 2 to detect the trailing end of the web.

As for the shape of the notched portion, the shaft diameter may be made small as shown in the drawing, or a similar effect can be obtained if a V-cut or a D-cut is formed in the shaft 2. In addition, the amount of the notch may be set in conformity with the sensitivity of the sensor, or may be made large for assurance's sake. A noncontact-type photo sensor or the like may be used as the sensor.

It should be noted that, as an example of the fixing unit used in the invention, a fixing unit for an electrophotographic apparatus is known which is used for fixing an unfixed toner image on recording paper formed by a photoconductor, a charging unit, an optical unit, a developing unit, and a transfer unit.

In this embodiment, the web may be impregnated with silicone oil to exhibit an oil applying function.

As described above, in accordance with the invention, since an output of the sensor fluctuates substantially after the trailing end of the web is disengaged from the winding shaft, the trailing end of the web can be detected easily without being affected by the sensitivity of the sensor, so that the unused web is prevented from being discarded wastefully.

What is claimed is:

1. A cleaning device for a fixing unit in which recording paper with an image formed thereon is passed through a nip between a pair of rollers including a heating roller and a pressure roller so as to fix the image formed on the recording paper, said cleaning device being adapted to effect cleaning by pressing the web against at least one of the heating roller and the pressure roller, said cleaning device comprising:
a winding shaft with an elongated unused web wound therearound;
a web takeup shaft disposed parallel to said winding shaft for taking up the web;
a roller for pressing the web against one of the heating roller and the pressure roller; and
a sensor for detecting a trailing end of the web, wherein a notched portion is formed in said winding shaft at a position opposing a detecting position of said sensor.

2. The cleaning device for a fixing unit according to claim 1, wherein the web is impregnated with silicone oil to exhibit an oil applying function.
